(19) United States
(12) Patent Application Publication
(10) Pub. No.: US 2009/0265782 A1
(43) Pub. Date: Oct. 22, 2009

(54) MOBILE STATION AND METHOD FOR AVOIDING ATTACKS

(75) Inventor: Cheng-Wen Tang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng,Taipei Hsien (TW)

(21) Appl. No.: 12/212,662

(22) Filed: Sep. 18, 2008

(30) Foreign Application Priority Data
Apr. 18, 2008 (CN) 200810301190.5

(51) Int. Cl. G06F 12/14

(52) U.S. Cl. 726/22

(57) ABSTRACT

A mobile station wirelessly communicates with an access point during an awake mode of the mobile station through a wireless network and avoids attacks from an attacking station. The mobile station includes a detecting module, an attack-proof module, and a data transmission module. The detecting mobile is configured for detecting a fake null frame from the wireless network during the awake mode. The fake null frame is for interrupting communication between the mobile station and the access point in order for the mobile station to enter a power saving mode. The attack-proof module is configured for transmitting an attack-proof frame to the access point so as to notify the access point that the mobile station has not entered into the power saving mode. The data transmission module is for transmitting data to the access point and receiving data from the access point. A method for avoiding attacks is also provided.

### BACKGROUND

1. Field of the Invention

Embodiments of the present disclosure relate to wireless communications, and particularly to a mobile station and a method for avoiding attacks.

2. Description of Related Art

FIG. 3 is a schematic diagram of a wireless communication system. The wireless communication system includes a mobile station 10, an access point 20, and an attacking station 30. The mobile station 10 wirelessly communicates with the access point 20 during its awake mode. The attacking station 30 transmits a fake null frame to the access point 20, posing as the mobile station 10, in order to deceive the access point 20 into assuming that the mobile station 10 has entered into a power saving mode, consequently interrupting the communication between the mobile station 10 and the access point 20.

The mobile station 10 does not respond when encountering the above situation. As a result, the access point 20 would assume that the mobile station 10 has entered into a power saving mode based on the fake null frame and cease to transmit data to the mobile station 10, which causes the mobile station 10 to be attacked by the fake null frame.

### SUMMARY

One embodiment of the present disclosure provides a mobile station. The mobile station wirelessly communicates with an access point during an awake mode of the mobile station through a wireless network and avoids attacks from an attacking station. The mobile station includes a detecting module, an attack-proof module, and a data transmission module. The detecting mobile is configured for detecting a fake null frame from the wireless network during the awake mode. The fake null frame is transmitted from the attacking station to the access point through the wireless network for interrupting communication between the mobile station and the access point in order for the mobile station to enter a power saving mode. The attack-proof module is configured for transmitting an attack-proof frame to the access point so as to notify the access point that the mobile station has not entered into the power saving mode. The data transmission module is configured for transmitting data to the access point and receiving data from the access point during the awake mode of the mobile station.

Another embodiment of the present disclosure provides a method for avoiding attacks from an attacking station to a mobile station. The mobile station wirelessly communicates with an access point during an awake mode of the mobile station through a wireless network. The method includes the blocks of: detecting a fake null frame from the wireless network during the awake mode of the mobile station, the fake null frame transmitted from the attacking station to the access point through the wireless network for interrupting communication between the mobile station and the access point in order for the mobile station to enter a power saving mode; transmitting an attack-proof frame from the mobile station to the access point so as to notify the access point that the mobile station has not entered into the power saving mode; and transmitting data from the mobile station to the access point and receiving data from the access point to the mobile station during the awake mode of the mobile station.

Other advantages and novel features of the present disclosure will become more apparent from the following detailed description of preferred embodiment when taken in conjunction with the accompanying drawings, in which:

### BRIEF DESCRIPTION OF THE DRAWINGS

FIG. 1 is a schematic diagram of an application environment and functional modules of a mobile station in accordance with one embodiment of the present disclosure;

FIG. 2 is a flowchart of one embodiment of a method for avoiding attacks in accordance with the present disclosure; and

FIG. 3 is a schematic diagram of a wireless communication system.

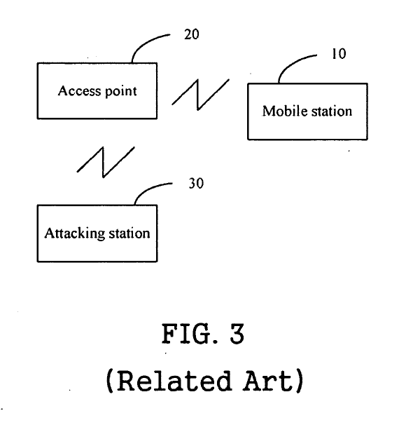

### DETAILED DESCRIPTION OF CERTAIN INVENTIVE EMBODIMENTS

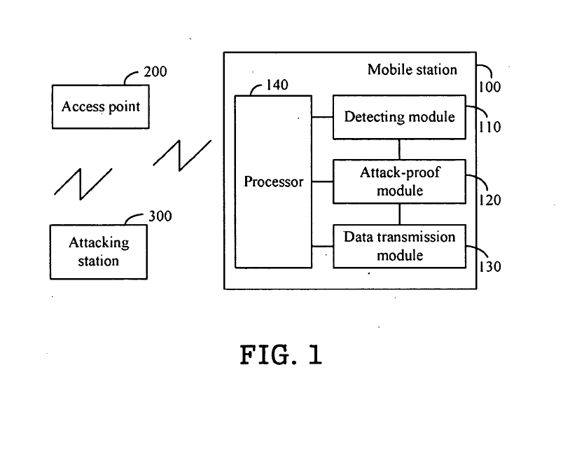

FIG. 1 is a schematic diagram of an application environment and functional modules of a mobile station 100 in accordance with one embodiment of the present disclosure. In one embodiment, the mobile station 100 wirelessly communicates with an access point 200 during its awake mode through a wireless network. The attacking station 300 transmits a fake null frame to the access point 200 through the wireless network, posing as the mobile station 100, in order to deceive the access point 200 into assuming that the mobile station 100 has entered into a power saving mode, consequently interrupting communication between the mobile station 100 and the access point 200. The mobile station 100 detects the fake null frame from the wireless network during its awake mode because the fake null frame is wirelessly transmitted from the attacking station 300 to the access point 200 through the wireless network. The mobile station 100 transmits an attack-proof frame to the access point 200 when detecting the fake null frame so as to notify the access point 200 that the mobile station 100 has not entered into a power saving mode to avoid the attack caused by the fake null frame and ensuring normal data transmission between the mobile station 100 and the access point 200.

In one embodiment, the mobile station 100 is a device that may connect to a wireless local area network (WLAN), which may be a mobile phone, a personal digital assistant, or a notebook computer, among other devices. The mobile station 100 includes a detecting module 110, an attack-proof module 120, a data transmission module 130, and a processor 140 for executing the detecting module 110, the attack-proof module 120, and the data transmission module 130. In one embodiment, the attacking station 300 is a device with a frame generator, which may connect to a WLAN. The attacking station 300 may be, for example, a mobile phone, a personal digital assistant, or a notebook computer.

The detecting module 110 is configured for detecting a fake null frame from the wireless network during the awake mode of the mobile station 100. The fake null frame is transmitted from the attacking station 300 to the access point 200 through the wireless network, and used by the attacking station 300 to deceive the access point 200 into assuming that the mobile station 100 has entered into a power saving mode. In one embodiment, the fake null frame includes a source address, a destination address, and a power save behavior (PSB) field. The source address is an address of a station that transmits the fake null frame. The destination address is an address of a destination station of the fake null frame. The PSB field indicates if the fake null frame transmitted has requested to enter into a power saving mode. The detecting module 110 receives a frame, and determines if the frame is a fake null frame based on its source address, destination address, and PSB field. The frame is defined as a fake null frame when the source address of the frame is an address of the mobile station 100, the destination address of the frame is an address of the access point 200, and the PSB field of the frame is 1. In one embodiment, addresses of the mobile station 100 and the access point 200 are both media access control (MAC) addresses.

The attack-proof module 120 is configured for transmitting an attack-proof frame to the access point 200 so as to notify the access point 200 that the mobile station 100 has not entered into the power saving mode to avoid an attack caused by the fake null frame. In one embodiment, the attack-proof frame may be a null frame or a data frame, and includes a source address, a destination address, and a PSB field. The source address of the attack-proof frame is set to the address of the mobile station 100, the destination address of the attack-proof frame is set to the address of the access point 200, and the PSB field of the attack-proof frame is set to 0.

The access point 200 determines that the mobile station 100 has not entered into a power saving mode when receiving the attack-proof frame.

The data transmission module 130 is configured for transmitting data to the access point 200 and receiving data from the access point 200 during the awake mode of the mobile station 100. In one embodiment, after the attack-proof module 120 avoids an attack caused by the fake null frame, the data transmission module 130 may normally transmit data to the access point 200 and receive data from the access point 200.

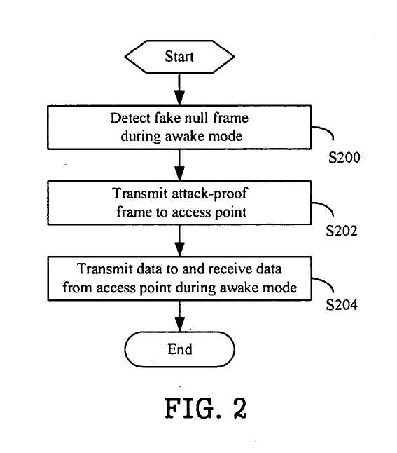

FIG. 2 is a flowchart of one embodiment of a method for avoiding attacks in accordance with the present disclosure.

In block S200, the detecting module 110 detects a fake null frame from a wireless network during an awake mode of the mobile station 100. The fake null frame is transmitted from the attacking station 300 to the access point 200 through the wireless network and used by the attacking station 300 to deceive the access point 200 into assuming that the mobile station 100 has entered into a power saving mode, consequently interrupting the communication between the mobile station 100 and the access point 200. In one embodiment, the detecting module 110 receives a frame, and determines that the frame is a fake null frame when the source address of the frame is the address of the mobile station 100, the destination address of the frame is the address of the access point 200, and the PSB field of the frame is 1.

In block S202, the attack-proof module 120 transmits an attack-proof frame to the access point 200 when detecting the fake null frame so as to notify the access point 200 that the mobile station 100 has not entered into a power saving mode to avoid an attack caused by the fake null frame. In one embodiment, the attack-proof frame may be a null frame or a data frame, and includes a source address, a destination address, and a PSB field, wherein the source address of the attack-proof frame is the address of the mobile station 100, the destination address of the attack-proof frame is the address of the access point 200, and the PSB field of the attack-proof frame is 0.

The access point 200 determines that the mobile station 100 has not entered into a power saving mode when receiving the attack-proof frame, and will transport data to the mobile station 100.

In block S204, the data transmission module 130 transmits data to the access point 200 and receives data from the access point 200 during the awake mode of the mobile station 100. In one embodiment, after the attack-proof module 120 avoids an attack caused by the fake null frame, the data transmission module 130 may normally transmit data to the access point 200 and receive data from the access point 200.

Thus, the mobile station 100 may successfully and conveniently avoid an attack caused by a fake null frame by using the detecting module 110 and the attack-proof module 120 to ensure normal data transmission between the mobile station 100 and the access point 200.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A mobile station for avoiding attacks from an attacking station, the mobile station wirelessly communicating with an access point through a wireless network during an awake mode of the mobile station, the mobile station comprising:
a detecting module configured for detecting a fake null frame from the wireless network during the awake mode of the mobile station, the fake null frame transmitted from the attacking station to the access point through the wireless network for interrupting communication between the mobile station and the access point in order for the mobile station to enter a power saving mode;
an attack-proof module configured for transmitting an attack-proof frame to the access point so as to notify the access point that the mobile station has not entered into the power saving mode; and
a data transmission module configured for transmitting data to the access point and receiving data from the access point during the awake mode of the mobile station.

2. The mobile station as claimed in claim 1, wherein the fake null frame comprises a source address, a destination address, and a power save behavior field, the source address is an address of a station that transmits the fake null frame, the destination address is an address of a destination station of the fake null frame, and the power save behavior field indicates if the fake null frame transmitted has requested to enter into a power saving mode.

3. The mobile station as claimed in claim 2, wherein the detecting module is further configured for receiving a frame, and determines that the frame is a fake null frame upon the condition that a source address of the frame is an address of the mobile station, the destination address of the frame is an address of the access point, and the power save behavior field of the frame is 1.

4. The mobile station as claimed in claim 3, wherein the attack-proof frame comprises a source address, a destination address, and a power save behavior field, the source address of the attack-proof frame is set to the address of the mobile station, the destination address of the attack-proof frame is set to the address of the access point, and the power save behavior field of the attack-proof frame is set to 0.

5. The mobile station as claimed in claim 4, wherein the attack-proof frame is a null frame.

6. The mobile station as claimed in claim 4, wherein the attack-proof frame is a data frame.

7. The mobile station as claimed in claim 1, wherein the mobile station comprises at least one of a mobile phone, a personal digital assistant, and a notebook computer.

8. The mobile station as claimed in claim 1, wherein the attacking station comprises at least one of a mobile station, a personal digital assistant, and a notebook computer.

9. A method for avoiding attacks from an attacking station to a mobile station, the mobile station wirelessly communicating with an access point during an awake mode of the mobile station through a wireless network, the method comprising:
(a) detecting a fake null frame from the wireless network during the awake mode of the mobile station, the fake null frame transmitted from the attacking station to the access point through the wireless network for interrupting communication between the mobile station and the access point in order for the mobile station to enter a power saving mode;
(b) transmitting an attack-proof frame from the mobile station to the access point so as to notify the access point that the mobile station has not entered into the power saving mode; and
(c) transmitting data from the mobile station to the access point and receiving data from the access point to the mobile station during the awake mode of the mobile station.

10. The method as claimed in claim 9, wherein the fake null frame comprises a source address, a destination address, and a power save behavior field, the source address is an address of a station that transmits the fake null frame, the destination address is an address of a destination station of the fake null frame, and the power save behavior field indicates if the fake null frame transmitted has requested to enter into a power saving mode.

11. The method as claimed in claim 10, wherein the block (a) comprises:
receiving a frame from the wireless network; and
determining that the frame is a fake null frame upon the condition that a source address of the frame is an address of the mobile station, the destination address of the frame is an address of the access point, and the power save behavior field of the frame is 1.

12. The method as claimed in claim 11, wherein the attack-proof frame comprises a source address, a destination address, and a power save behavior field, the source address of the attack-proof frame is set to the address of the mobile station, the destination address of the attack-proof frame is set to the address of the access point, and the power save behavior field of the attack-proof frame is set to 0.

13. The method as claimed in claim 12, wherein the attack-proof frame is a null frame.

14. The method as claimed in claim 12, wherein the attack-proof frame is a data frame.
